(19) United States
(12) Patent Application Publication
(10) Pub. No.: US 2012/0277457 A1
(43) Pub. Date: Nov. 1, 2012

(54) AMINOSILANES AND METHODS FOR MAKING SAME

(75) Inventors: John Francis Lehmann, Bethlehem, PA (US); Howard Paul Withers, JR., Breinigsville, PA (US)

(73) Assignee: AIR PRODUCTS AND CHEMICALS, INC., Allentown, PA (US)

(21) Appl. No.: 13/251,684

(22) Filed: Oct. 3, 2011

Related U.S. Application Data
(60) Provisional application No. 61/392,180, filed on Oct. 12, 2010.

(51) Int. Cl. C07F 7/02

(52) U.S. Cl. 556/410

(57) ABSTRACT

Aminosilanes, such as diisopropylaminosilane (DIPAS), are precursors for the deposition of silicon containing films such as silicon-oxide and silicon-nitride films. Described herein are methods to make these aminosilanes as well as intermediate compounds such as haloaminosilane compounds having the following formula:

X₄₋ₙHₙ₋₁SiN(CH(CH₃)₂)₂

wherein n is a number selected from 1, 2 and 3; and X is a halogen selected from Cl, Br, or a mixture of Cl and Br provided that when X is Cl, n is not 1.

### CROSS REFERENCE TO RELATED APPLICATIONS

This application claims the benefit of U.S. Provisional Application No. 61/392,180, filed on Oct. 12, 2010. The disclosure of Application No. 61/392,180 is hereby incorporated by reference.

### BACKGROUND OF THE INVENTION

Described herein are methods for making an aminosilanes, such as for example, diisopropylaminosilane. Also described herein are halo-aminosilane compounds that may be useful, for example, as chemical intermediates.

Aminosilanes containing the —SiH₃ or —SiH₂— moieties are desirable precursors for the deposition of silicon oxide and silicon nitride films or doped versions thereof. Volatile aminosilane compounds are important precursors used for the deposition of silicon-oxide and silicon nitride films or doped variants thereof in the manufacture of semiconductor devices. One particular embodiment of an aminosilane compound is diisopropylaminosilane (DIPAS), which has previously been shown to exhibit desirable physical properties for the controlled deposition of such films. Although DIPAS can be prepared by the direct reaction of diisopropylamine (DIPA) or lithium-diisopropylamide with monochlorosilane (MCS), MCS is not an abundant commodity chemical and is therefore subject to limited availability and price instability. Furthermore, synthesis of aminosilanes using MCS may produce stoichiometric amounts of amine hydrochloride salts that can be highly absorbent thereby complicating recovery of aminosilane products.

The prior art describes some methods for the production of aminosilane compounds which typically involve one or more solvents. Prior to use, the solvent needs to be purified and dried to prevent the introduction of impurities in the end-product and dried to the prevent the newly-formed compound from hydrolyzing to siloxane and its respective amine. The articles, K. N. Radhamani et al., “High Yield Room Temperature Synthesis and Spectral Studies of Tri(amino)silanes: (R₂N)₃SiH”, Phosphorous, Sulfur, and Silicon, Vol. 66 (1992), pp. 297-300 (“Radhamani I”) and K. N. Radhamani et al., “A Convenient High Yield Room Temperature Synthesis of Mixed Tri(amino)silanes by Transamination of Tris(cyclohexylamino)silane and Their Characterization”, Phosphorous, Sulfur, and Silicon, Vol. 79 (1993), pp. 65-68 (“Radhamani II”), describe similar reactions for the synthesis of triaminosilanes and mixed aminosilanes, respectively. Radhamani I describes reacting a secondary amine (R₂NH) with trichlorosilane to form (R₂N)₃SiH and 3R₂NH.HCl salt. Similarly, Radhamani II describes reacting dicyclohexylamine with trichlorosilane to form tris(dicyclohexylamino)silane and dicyclohexyamine.HCl salt. Both reactions are conducted at a temperature near room temperature under a nitrogen atmosphere using a benzene/n-hexane mix as the solvent. The benzene and n-hexane solvents were purified via distillation and dried via sodium wire prior to use within the reaction.

U.S. Pat. No. 6,963,003, which is owned by the assignee of the present application, provides a method for preparing an aminosilane compound comprising reacting a stoichiometric excess of at least one amine selected from the group consisting of secondary amines having the formula R1₂NH, tertiary amines having the formula R2NH₂ or combinations thereof with at least one chlorosilane having the formula R3ₙSiCl₄, under anhydrous conditions sufficient such that a liquid comprising the aminosilane product and an amine hydrochloride salt is produced wherein R1 and R2 can each independently be a linear, cyclic or branched alkyl group having 1 to 20 carbon atoms; R3 can be a hydrogen atom, an amine group, or a linear, cyclic or branched alkyl group having 1 to 20 carbon atoms; and n is a number ranging from 1 to 3. In certain embodiments, one or more of the steps of the method is conducted in the absence of an organic solvent.

Korean Patent No. 10-1040325 provides a method for preparing an alkylaminosilane which involves reacting a secondary amine and trichloroaminosilane in an anhydrous atmosphere and in the presence of a solvent to form an alkyl aminochlorosilane intermediate and a metal hydrid LiAlH₄ is added to the alkyl aminochlorosilane intermediate as a reducing agent to form the alkylaminosilane. The alkylaminosilane is then subjected to a distillation process to separate and purify the alkylaminosilane.

There is a need to provide a method of making aminosilanes, such as DIPAS, using commercially available reagents in yields comparable to those methods that use MCS precursor. There is also a need to provide a method of making aminosilanes, such as DIPAS, by a means that eliminates or facilitates the separation of the product from reaction mixture and particularly that addresses the adsorbent natures of amine-hydrohalide salts. There is a need to provide methods of making aminosilanes that reduces the overall production costs by reducing the costs of reagents used and/or reducing agents. There is a further need in the art to provide methods of preparing haloaminosilanes or mixed halo-hydrido-aminosilanes, which hold potential as unique precursors to silicon-nitride and silicon-oxide films and/or useful chemical intermediates for the production of other aminosilanes used for these or other purposes.

### BRIEF SUMMARY OF THE INVENTION

The method and compounds described herein fulfill at least one of the needs in the art. In one aspect, there is provided a haloaminosilane compounds having the following formula:

X₄₋ₙHₙ₋₁SiN(CH(CH₃)₂)₂

wherein n is a number selected from 1, 2 and 3; and X is a halogen selected from Cl, Br, or a mixture of Cl and Br, provided that when X is Cl, n is not 1 or 2 wherein the haloaminosilane compound is used as an intermediate for the preparation of an aminosilane compound and/or as a precursor for the deposition of a silicon containing film. In certain embodiments, X is Br or a mixture of Cl and Br. Examples of particular intermediate haloaminosilane compounds described herein, include but are not limited to Br₃SiN(CH(CH₃)₂)₂, ClBr₂SiN(CH(CH₃)₂)₂, Cl₂BrSiN(CH(CH₃)₂)₂, HBr₂SiN(CH(CH₃)₂)₂, H₂BrSiN(CH(CH₃)₂)₂, and HClBrSiN(CH(CH₃)₂)₂.

In another aspect, there is provided a method for making a haloaminosilane compound having the following formula:

X₄₋ₙHₙ₋₁SiN(CH(CH₃)₂)₂

wherein n is a number selected from 1, 2 and 3; and X is a halogen selected from Cl, Br, or a mixture of Cl and Br, wherein the method comprises the steps of: reacting a halosilane having the formula HₙSiX₄₋ₙ wherein n is 0, 1, or 2 and X is Cl, Br, or a mixture of Cl and Br and an amine to provide the haloaminosilane compound. In one particular aspect, the reacting step is conducted in the presence of a solvent. In another particular aspect, the reacting step is conducted in the absence of a solvent.

In yet another aspect, there is provided a method for making an aminosilane compound having the following formula:

H₃SiNR¹R²

wherein R¹ and R² are each independently selected from C₁-C₁₀ linear, branched or cyclic, saturated or unsaturated, aromatic, heterocyclic, substituted or unsubstituted alkyl groups wherein R¹ and R² are linked to form a cyclic group or wherein R¹ and R² are not linked to form a cyclic group, comprising the steps of: reacting a halosilane having the formula HₙSiX₄₋ₙ wherein n is 0, 1, or 2 and X is Cl, Br, or a mixture of Cl and Br, and an amine to provide a slurry comprising a haloaminosilane compound X₄₋ₙHₙ₋₁SiN(CH(CH₃)₂)₂ wherein n is a number selected from 1, 2 and 3; and X is a halogen selected from Cl, Br, or a mixture of Cl and Br; and introducing into the slurry a reducing agent wherein at least a portion of the reducing agent reacts with the haloaminosilane compound and provides an end product mixture comprising the aminosilane compound.

In a further aspect, there is provided a method for making an aminosilane compound having the following formula:

H₃SiNR¹R²

wherein R¹ and R² are each independently selected from C₁-C₁₀ linear, branched or cyclic, saturated or unsaturated, aromatic, heterocyclic, substituted or unsubstituted alkyl groups wherein R¹ and R² are linked to form a cyclic group or wherein R¹ and R² are not linked to form a cyclic group which comprises the steps of: reacting a halosilane having the formula HₙSiX₄₋ₙ wherein n is 0, 1, or 2 and X is Cl, Br, or a mixture of Cl and Br, and an amine to provide a slurry comprising a haloaminosilane compound

X₄₋ₙHₙ₋₁SiN(CH(CH₃)₂)₂

wherein n is a number selected from 1, 2 and 3; and X is a halogen selected from Cl, Br, or a mixture of Cl and Br, provided that when X is Cl, n is not 1 and a amine-hydrohalide byproduct; and introducing into the slurry a reducing agent wherein at least a portion of the reducing agent reacts with the haloaminosilane compound and provides an end product mixture comprising the aminosilane compound and optionally reducing agent. In this or other embodiments, the method further comprises the step of adding a neutralizing agent to the end product mixture to remove at least a portion of reducing agent comprised therein.

In yet another embodiment, there is provided a haloaminosilane compound having the following formula:

X₄₋ₙHₙ₋₁SiN(CH(CH₃)₂)₂

wherein n is a number selected from 1, 2 and 3; and X is a halogen selected from Cl, Br, or a mixture of Cl and Br, provided that when X is Cl, n is not 1 or 2. Examples of particular intermediate haloaminosilane compounds described herein, include but are not limited to, Br₃SiN(CH(CH₃)₂)₂, ClBr₂SiN(CH(CH₃)₂)₂, Cl₂BrSiN(CH(CH₃)₂)₂, HBr₂SiN(CH(CH₃)₂)₂, H₂BrSiN(CH(CH₃)₂)₂, and HClBrSiN(CH(CH₃)₂)₂.

### DETAILED DESCRIPTION OF THE INVENTION

Methods for preparing aminosilanes, such as but not limited to diisopropylaminosilane (DIPAS), having the general formula H₃SiNR¹R² wherein R¹ and R² are each independently selected from C₁-C₁₀ linear, branched or cyclic, saturated or unsaturated, aromatic, heterocyclic, substituted or unsubstituted alkyl groups from a reaction mixture comprising an amine and a halosilane reagent in the presence or absence of a secondary solvent to form an intermediate, followed by reduction of the intermediate with a hydride are disclosed herein. The methods described herein provide a means to synthesize desirable aminosilanes, such as but not limited to DIPAS, in yields that are comparable to those obtained by methods utilizing monochlorosilane precursor. Exemplary yields obtainable for the organosilanes using the method described herein are 50 mol % or greater, 55 mol % or greater, 60 mol % or greater, 65 mol % or greater, 70 mol % or greater, 75 mol % or greater, 80 mol % or greater, or 90 mol % or greater based on the halosilane usage. In one particular embodiment, the method described herein eliminates the need to separate the desired aminosilane product from bulky and adsorbent amine hydrohalide solids. The methods described herein also demonstrate the ability to selectively reduce the silicon-chlorine and silicon-bromine bonds of halo-aminosilanes and halo-hydridoaminosilanes with retention of the amino-functionalities, despite prior art teachings that hydride reduction eliminates amino-functionalities. With exception to Cl₃SiN(CH(CH₃)₂)₂, also disclosed herein are new haloaminosilane compounds comprising the formula X₄₋ₙHₙ₋₁SiN(CH(CH₃)₂)₂ where n is a number selected from 1, 2 and 3; and X is a halogen selected from Cl, Br, or a mixture of Cl and Br. The haloaminosilane compounds described herein may be useful, for example, as precursor to Si—N and/or Si—O films, or, alternatively, as chemical intermediates to be used for the preparation of other aminosilanes.

In the method described herein, an amine is first reacted with a halosilane to form an intermediate slurry comprising a halogenated or partially-halogenated aminosilane and a stoichiometric quantity of the amine-hydrohalide salt. In these embodiments, the halosilane reagent may include compounds having the formula HₙSiX₄₋ₙ wherein n is 0, 1 or 2 and X is Cl, Br or a combination thereof. The amine reagents may include primary (H₂NR), secondary (HNR¹R²) or cyclic amines containing linear or branched organic R, R¹ and R² functionalities, though it is preferable that alkyl functionalities be sufficiently large to afford stability during hydride reduction of the halo-aminosilane and storage of the final aminosilane product. Exemplary amines include, but are not limited to diisopropylamine, t-butylamine, n-butylamine and piperidine. Tertiary amines, such as but not limited to trimethylamine, ethyl dimethylamine, N-methylpyrrolidine, tertiary butylamine, tripropylamine, tributylamine, tripentylamine, trihexylamine, N-methyl-N-propyl-N-butylamine, and N-ethyl-N-isopropyl-N-butylamine, may also be added to the reaction mixture to selectively form the tertiary-amine hydrohalide byproduct thereby increasing the efficiency of the primary, secondary or cyclic amine incorporation into the halosilane intermediate.

The molar ratio of halosilane to the amine in the reaction mixture ranges from 1 to 1, from 1 to 2, from 1 to 2.2, or from 1 to 10. In one particular embodiment, the reaction mixture has a 1:2.1 to 1:2.2 molar ratio of halosilane to amine to ensure the reaction proceeds quickly to completion. In embodiments wherein the halosilane reagent comprises SiX₄, where X═Cl, Br, or combinations thereof, the reaction may yield solely the singly substituted amine derivative and be insensitive to higher amine ratios. A particular embodiment is the example with diisopropylamine for which the reaction with excess amine yields only the trihalo-diisopropylaminosilane when contacted with SiCl₄ or SiBr₄. In embodiments wherein the halosilane reagent in the reaction mixture comprises trichlorosilane, and excess diisopropylamine is used as the amine modifier, the dihalo-(bis)diisopropylaminosilane compound is also formed. Consequently, for certain embodiments, the use of tetrahalosilane reagents may be preferred if high yields and selectivity of a (mono)aminosilane end product are desired though this may come at the expense of greater quantities of reducing agent being used during the reduction step.

In certain embodiments, the reaction mixture comprising the halosilane reagent(s) and amine reagent(s) further comprises an anhydrous solvent. Exemplary solvents may include, but are not limited to linear-, branched-, cyclic- or poly-ethers (e.g., tetrahydrofuran (THF), diethyl ether, diglyme, and/or tetraglyme); linear-, branched-, or cyclic-alkanes, alkenes, aromatics and halocarbons (e.g. pentane, hexanes, toluene and dichloromethane). The selection of one or more solvent, if added, may be influenced by its compatibility with reagents contained within the reaction mixture, the subsequent hydride reduction process and/or the separation process for the intermediate product and/or the end product chosen. In other embodiments, the reaction mixture does not comprise a solvent. In these or other embodiments, the amine reagent may be used as the liquid medium for the reaction in the reaction mixture.

In the method described herein, the reaction between the halosilane reagent(s) and the amine reagent(s) occurs at one or more temperatures ranging from about 0° C. to about 80° C. Exemplary temperatures for the reaction include ranges having any one or more of the following endpoints: 0, 10, 20, 30, 40, 50, 60, 70, or 80° C. The suitable temperature range for this reaction may be dictated by the physical properties of the halosilane reagent(s), amine reagent(s) and optional solvent. Examples of particular reactor temperature ranges include but are not limited to, 0° C. to 80° C. or from 0° C. to 30° C.

In certain embodiments of the method described herein, the pressure of the reaction may range from about 1 to about 115 psia or from about 15 to about 45 psia. In one particular embodiment, the reaction is run at a pressure ranging from 15 to 20 psia.

In certain embodiments, one or more reagents may be introduced to the reaction mixture as a liquid or a vapor. In embodiments where one or more of the reagents is added as a vapor, a non-reactive gas such as nitrogen or an inert gas may be employed as a carrier gas to deliver the vapor to the reaction mixture. In embodiments where one or more of the reagents is added as a liquid, the regent may be added neat, or alternatively diluted with a solvent. The reagent is fed to the reaction mixture until the desired conversion to the crude slurry containing the intermediate haloaminosilane product, or crude liquid, has been achieved. In certain embodiments, the reaction may be run in a continuous manner by replenishing the halosilane and/or amine reagents and removing the reaction products such as the intermediate halo-aminosilane product and the crude liquid from the reactor.

An example of the process chemistry for one particular embodiment of the method described herein is presented in the following equation:

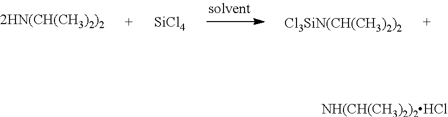

Referring to the above equation, the crude slurry is formed by the reaction of silicon tetrachloride and diisopropylamine (DIPA). Two moles of DIPA are consumed for each mole of SiCl₄ reacted. A 20% stoichiometric excess of amine is generally used to ensure complete reaction, though smaller excesses may be used if the mixing period is adequately long. The crude fluid contains 1 mole of diisopropylamine hydrochloride salt for each mole of SiCl₄ reacted. The product of the reaction between the halosilane reagent(s) and the amine reagent(s) is a crude slurry that comprises the intermediate halo-aminosilane compound, excess amine reagent, excess solvent if present in the reaction mixture, and amine-hydrohalide byproduct. The term “slurry” as used herein describes liquid, gas, vapor, solids, and combinations thereof. More generally, the intermediate halo-aminosilanes within the crude slurry are compounds having the formula X₄₋ₙHₙ₋₁SiNR¹R² where n is a number selected from 1, 2 and 3; and X is a halogen selected from Cl, Br, or a mixture of Cl and Br. The anticipated yield of intermediate haloaminosilane compounds within the crude fluid ranges from 70% or greater, or 80% or greater, or 90% or greater of the theoretical yield with respect to the halosilane precursor. As previously mentioned, the intermediate haloaminosilane compounds may be used as a precursor to a silicon containing film, or, alternatively, as a chemical intermediate to be used for the preparation of other aminosilanes.

The crude slurry comprising the intermediate halo-aminosilane may be used in the subsequent reduction step to provide the end product mixture comprising the aminosilane or, alternatively, subjected to a separation step to remove the amine hydrohalide byproduct prior to the reduction step. With regard to the later, the crude slurry can be subjected to one or more processes to substantially remove the amine hydrohalide salt and if necessary any co-reagents such as solvents or tertiary amines. The removal of the amine hydrohalide byproduct from the crude slurry is generally optional prior to the reducing or reduction step unless an incompatible solvent or co-reagent has been used in the first step of the reaction. The reaction conditions of temperature and pressure for the separation of the crude fluid vary depending upon the process used. Examples of suitable separation processes include, but are not limited to, distillation, evaporation, membrane separation, filtration, vapor phase transfer, extraction, fractional distillation using an inverted column, and combinations thereof. In particular embodiments, the crude fluid is separated by distillation to extract the volatile intermediate halo-aminosilane compound contained therein. In these embodiments, the pressure can vary considerably from atmospheric to full vacuum and the temperatures can vary considerably from 0 to 180° C. or from 20 to 90° C. While the addition of a separation step may increase the process time and decrease the yield of the end product comprising organoaminosilane, the optional separation step for the intermediate haloaminosilane compound may reduce the amount of hydride reducing agent required in the subsequent reducing step of the method and consequently the raw material cost of overall method.

During the reduction step, the intermediate halo-aminosilane compound is converted to the desired aminosilane by the addition of one or more hydride-type reducing agents. The reduction can be performed on either the crude slurry containing the halo-aminosilane and amine-hydrohalide, or a purified stream in which only the halo-aminosilane requires reducing. Exemplary hydride reducing agents include, but are not limited to, alkali aluminum hydrides, alkali borohydrides, alkali germanium hydrides, alkali hydrides, and/or alkaline earth hydrides. The choice of suitable hydride reducing agent may depend upon a variety of factors, including but are not limited to, the desired efficiency of hydride utilization, the downstream purification method, and the degree of reduction desired. In one particular embodiment, the hydride reducing agents are salts having the formula MAlH₄ wherein M is an alkali metal such as lithium, sodium, potassium, rubidium, or cesium. In these embodiments, it is believed that alkali metal salts having the formula MAlH₄ may provide the best efficiency of hydride use, reaction progression and highest H₃SiNR¹R² yields, but may also produce soluble byproducts that may require purification by distillation.

In one particular embodiment, it was shown that the crude slurry consisting of equimolar quantities of Cl₃SiN(CH(CH₃)₂)₂ and HN(CH(CH₃)₂)₂.HCl was effectively reduced to DIPAS, DIPA and H₂ by the addition of a 1.4 mole equivalent of LiAlH₄ in tetrahydrofuran. Due to the partial consumption of LiAlH₄ by reduction of the amine-hydrochloride to hydrogen and amine in this embodiment, improved hydride utility can be afforded by separation of the salt prior to the reduction. In this or other embodiments, the use of the reducing agent can be used as an alternative to removing the solid amine-hydrohalide byproduct by traditional separation techniques. In other embodiments, the hydride reducing agent comprises an alkali or an alkaline metal hydrides such as LiH or NaH that can be used to reduce the intermediate halo-aminosilane compound or crude slurry comprising same and the amine hydrohalide salt. The alkali(ne) metal hydrides are advantageous in that the reduction byproduct is generally an insoluble metal halide salt (e.g., NaCl), though the reduction efficiency is generally lower when compared to those of the alkali aluminum hydrides. In instances that the formentioned hydrides react slowly, a catalyst may be used to promote the reaction. The catalyst which is typically added as a 5% contribution to the primary reducing agent may be selected from among the preceding reducing agents, but may also include, for example, aluminum(III) chloride, aluminum(III) bromide or alkali metal aluminum hydrides, or borohydrides that have partial bromide or chloride substitution (e.g., NaAlH₃Cl, LiBHCl₃, etc.).

The reduction is preferably performed in a linear, branched, and cyclic or polyethers solvent or any of the solvents described herein, however, any solvent that is inert or has limited reactivity towards the precursors, intermediate halo-aminosilanes, amine hydrohalide byproduct and hydride reducing agent can conceivably be used. The reduction step is preferably completed at or near ambient temperature, which minimizes vaporization of the preferred solvents while allowing the reaction to proceed at substantial rate.

The end product mixture comprises the aminosilane, amine, solvent if added, excess hydride reducing agent, and reduction byproducts (e.g., LiAlHCl₃, NaCl, etc.). In certain embodiments of the method described herein, the reduction step may leave excess active hydride reducing agent in the end product mixture. In these embodiments, the hazards associated with the excess hydride reducing agent used for the reductive hydrogenation of the intermediate haloaminosilane product is compounded during purification when its concentration is increased in a waste stream. To remedy these hazards, an optional neutralizing step may be performed wherein a neutralizing agent such as HCl or HBr may be added to the end product mixture either in pure form, diluted in the form of a gas mixture or complex salt (e.g., diisopropylamine hydrochloride), or combinations thereof. The hydrohalides are readily reduced by the remaining hydride to form byproducts that are either already present and/or less consequential to the remaining end product mixture. An example of this neutralization is shown in the following reactions:

LiAlHCl₃+HCl→LiCl+AlCl₃+H₂

NaH+DIPA.HCl→NaCl+DIPA+H₂

The hydride neutralization step is preferably done below the boiling point of the crude product components.

The method used to separate the end product comprising the organoaminosilane and solvent from the byproducts generated by the reducing agent from the end product mixture is largely dictated by the solvents and reducing agent used. In embodiments wherein the reducing agent byproducts are soluble, the product and co-solvents may be removed in the vapor phase under sub atmospheric pressure and/or elevated temperature (e.g., one or more temperatures ranging from about 20 to about 130° C.). In embodiments wherein the reducing agent by-products are insoluble, the removal of solvent and end product can alternatively be conducted by filtration.

Final purification of aminosilane product from co-solvents, excess amine and byproducts can be achieved by standard distillation methods above, at, or below atmospheric pressure. In one embodiment, it was demonstrated that diisopropylaminosilane fractions in excess of 96% purity could be recovered from a crude mixture of DIPAS, DIPA and tetrahydrofuran.

The following examples illustrate the method for preparing an intermediate haloaminosilane compound or an organoaminosilane compound described herein and is not intended to limit it in any way.

### EXAMPLES

For the following examples, gas chromatography (GC-TCD) and ¹H NMR spectroscopy were used to identify and quantify the solution compositions as appropriate. Gas chromatographic analyses were carried out on the product effluent using a TCD equipped HP-5890 Series II GC and a 0.53 mm diameter×30 m Supleco column containing 3 μm thick SPB-5 media.

### Example 1

### Synthesis of the Haloaminosilane Compound Br₃SiN(CH(CH₃)₂)₂

Silicon tetrabromide (0.01438 mol) and 150 mL dichloromethane solvent were added to a 250 mL 3-neck round bottom flask in a nitrogen purge box. The flask was transferred to a gas manifold where it was cooled to 0° C. and a N₂ purge was established. Diisopropylamine (0.03000 mol) dissolved in 159 mL of CH₂Cl₂ was then added dropwise to this solution using a drop funnel to produce a colorless solid suspended in the solution. A GC-TCD trace of the liquid phase showed near-complete consumption of SiBr₄ and the production of a single product, identified as Br₃SiN(CH(CH₃)₂)₂ by the isotopic signature of the parent molecular ion in the GC-MS spectrum and the ¹H NMR spectrum. The solvent, excess diisopropylamine and Br₃SiN(CH(CH₃)₂)₂ product were isolated from the DIPA.HBr byproduct by flash distillation of the volatiles to a −78° C. receiver under static vacuum.

### Example 2

### Synthesis of HCl₂SiN(CH(CH₃)₂)₂ and its Reduction to Diisopropylaminosilane Using the Reducing Agent NaAlH₄

A sample of HCl₂SiN(CH(CH₃)₂)₂ was prepared by dropwise addition of neat diisopropylamine (0.109 mol) to SiHCl₃ (0.0495 mol) in diethyl ether solvent. Monitoring the reaction by GC-TCD revealed that HCl₂SiN(CH(CH₃)₂)₂ is formed selectively when the DIPA:SiHCl₃ ratio is near 2:1. Prolonged reaction with 50 mol % excess DIPA at ambient temperature produces HCl₂SiN(CH(CH₃)₂)₂ in addition to HClSi(N(CH(CH₃)₂)₂)₂. This contrasts with the reactivities of SiCl₄ and SiBr₄, which do not react with excess DIPA to form X₂Si(N(CH(CH₃)₂)₂)₂ (X═Cl, Br) or higher aminated halo-aminosilanes.

The intermediate product slurry containing HCl₂SiN(CH(CH₃)₂)₂ and diisopropylamine hydrochloride was reduced to H₃SiN(CH(CH₃)₂)₂ by addition of a 58 mol % excess of NaAlH₄ (based on SiHCl₃ precursor used). The product composition was verified by GC-TCD and ¹H NMR spectroscopy, and yields of the crude product based on SiHCl₃ use were in excess of 73%. The use of SiHCl₃ precursor in the present example is advantageous because it requires less of the expensive reducing agent LiAlH₄ in the reaction mixture to synthesize the aminosilane product.

### Example 3

### Reduction of Cl₃SiN(CH(CH₃)₂)₂ to H₃SiN(CH(CH₃)₂)₂ Using LiAlH₄ in the Absence of Diisopropylamine Hydrochloride

A sample of Cl₃SiN(CH(CH₃)₂)₂ (0.0441 mol) was prepared by the general procedure described for Br₃SiN(CH(CH₃)₂)₂ in example 1, using THF in place dichloromethane as the solvent. Approximately 0.0113 mol of product and the excess solvent were transferred to a receiver during the flash distillation process. The product was combined with LiAlH₄ dissolved in THF and the progress of the reaction was monitored by GC-TCD. Residual Cl₃SiN(CH(CH₃)₂)₂ was negligible in the GC-TCD chromatogram when the Cl₃SiN(CH(CH₃)₂)₂:LiAlH₄ molar ratio reached 2:3, with the evolution H₃SiN(CH(CH₃)₂)₂ as the dominant product identified by the GC-TCD retention time and ¹H NMR spectrum.

### Example 4

### Reduction of Cl₃SiN(CH(CH₃)₂)₂ to H₃SiN(CH(CH₃)₂)₂ Using LiAlH₄ in the Presence of Diisopropylamine Hydrochloride

Diisopropylamine (0.173 mol) was added to a reaction mixture containing SiCl₄ (0.0662 mol) in 37.5 mL of THF to produce a DIPA.HCl slurry containing an equimolar quantity of Cl₃SiN(CH(CH₃)₂)₂. Lithium aluminum hydride (0.0911 mol) in THF solvent (ca 1.7 mol/L) was added dropwise to the DIPA.HCl/Cl₃SiN(CH(CH₃)₂)₂ mixture. During the initial stages of the reduction, copious amounts of H₂ gas were evolved and the slurry dissipated to yield a transparent solution free of solids indicating preferential reduction of DIPA.HCl over Cl₃SiN(CH(CH₃)₂)₂, which was confirmed by GC-TCD. Reduction of the Cl₃SiN(CH(CH₃)₂)₂ proceeded during the latter part of the LiAlH₄ addition, during which, the intermediate hydrochloroaminosilanes, Cl₂HSiN(CH(CH₃)₂)₂ and ClH₂SiN(CH(CH₃)₂)₂, were identified by periodic GC-TCD sampling. Upon completion of the reduction, flash distillation to a −78° C. receiver under static vacuum yielded a mixture of diisopropylaminosilane, diisopropylamine, and THF containing only a trace amounts of Cl₃SiN(CH(CH₃)₂)₂, and no signs of the intermediate hydrochloroaminosilanes.

Subsequent reactions performed using this general procedure showed that the yield of H₃SiN(CH(CH₃)₂)₂ contained in the crude distillate can exceed 90 mol % based on the initial quantity of SiCl₄ used. Moreover, fractional distillation of the crude distillate readily yields H₃SiN(CH(CH₃)₂)₂ in greater than 95% purity (balance 4.1% DIPA, <0.1% THF).

### Example 5

### Reduction of Cl₃SiN(CH(CH₃)₂)₂ with NaH Reducing Agent and Catalytic Amounts of LiAlH₄/NaBH₄

A sample of Cl₃SiN(CH(CH₃)₂)₂ was prepared by addition of neat diisopropylamine (0.125 mol) to SiCl₄ (0.05 mol) in diglyme under a N₂ atmosphere. A separate mixture containing NaH (0.340 mol), LiAlH₄ (0.0034 mol) and NaBH₄ (0.0090 mol) was slowly added to the Cl₃SiN(CH(CH₃)₂)₂/DIPA.HCl reaction mixture and the reaction mixture was warmed to approximately 40° C. The reduction of the Cl₃SiN(CH(CH₃)₂)₂/DIPA.HCl reaction mixture was slower with this method than by the pure LiAlH₄ method described in example 3, however, GC-TCD and ¹H NMR spectroscopy confirmed the production of DIPAS after several hours in quantities exceeding that which could be solely attributable to the reduction capacity of the LiAlH₄/NaBH₄ catalyst alone.

### Example 6

### In Process Reduction of Excess Nah by Addition of a Hydrogen Chloride Containing Neutralizing Agent

The crude product H₃SiN(CH(CH₃)₂)₂ produced by the reduction of Cl₃SiN(CH(CH₃)₂)₂ (ca 0.050 mol) with NaH (0.454 mol) and a catalytic NaBH₄ (0.048 mol)/LiAlH₄ (0.001 mol) in diglyme was slowly treated with 0.257 mol of diisopropylamine hydrochloride. After the H₂ evolution ceased, the H₃SiN(CH(CH₃)₂)₂ containing end product was filtered to remove the insoluble NaCl and any remaining DIPA.HCl. Subsequent hydrolysis of the filter cake did not produce any violent exotherms as would be expected if NaH was still present.

1. A haloaminosilane compound having the following formula:
X₄₋ₙHₙ₋₁SiN(CH(CH₃)₂)₂
wherein n is a number selected from 1, 2 and 3; and X is a halogen selected from Cl, Br, or a mixture of Cl and Br, provided that when X is Cl, n is not 1 or 2,
wherein the haloaminosilane compound is used as an intermediate for the preparation of an aminosilane compound having the following formula:
H₃SiNR¹R²
wherein R¹ and R² are each independently selected from C₁-C₁₀ linear, branched or cyclic, saturated or unsaturated, aromatic, heterocyclic, substituted or unsubstituted alkyl groups wherein R¹ and R² are linked to form a cyclic group or wherein R¹ and R² are not linked to form a cyclic group.

2. The haloaminosilane of claim 1 wherein X is Cl.

3. The haloaminosilane of claim 2 wherein X is Br.

4. The haloaminosilane of claim 1 wherein X is Cl and Br.

5. A method for making a haloaminosilane compound having the following formula:
X₄₋ₙHₙ₋₁SiN(CH(CH₃)₂)₂
wherein n is a number selected from 1, 2 and 3; and X is a halogen selected from Cl, Br, or a mixture of Cl and Br, provided that when X is Cl, n is not 1 or 2, the method comprising the steps of:
reacting a halosilane having the formula HₙSiX₄₋ₙ wherein n is 0, 1, or 2 and X is Cl, Br, or a mixture of Cl and Br, and an amine to provide the haloaminosilane compound.

6. The method of claim 5 wherein the reacting is conducted in the presence of a solvent.

7. The method of claim 6 wherein the solvent is an anhydrous solvent.

8. The method of claim 5 wherein the reacting is conducted in the absence of a solvent.

9. A method for making an aminosilane compound having the following formula:
X₄₋ₙHₙ₋₁SiN(CH(CH₃)₂)₂
wherein X is a halogen selected from Cl, Br, or a mixture of Cl and Br, provided that when X is Cl, n is not 1 or 2; R¹ and R² are each independently selected from C₁-C₁₀ linear, branched or cyclic, saturated or unsaturated, aromatic, heterocyclic, substituted or unsubstituted alkyl groups, and n is a number selected from 1, 2 and 3, the method comprising the steps of:
reacting a halosilane having the formula HₙSiX₄₋ₙ wherein n is 0, 1, or 2 and X is Cl, Br, or a mixture of Cl and Br, and an amine to provide a slurry comprising a haloaminosilane compound X₄₋ₙHₙ₋₁SiN(CH(CH₃)₂)₂ wherein n is a number selected from 1, 2 and 3; and X is a halogen selected from Cl, Br, or a mixture of Cl and Br, provided that when X is Cl, n is not 1 or 2 and a amine-hydrohalide byproduct; and
introducing into the slurry a reducing agent wherein at least a portion of the reducing agent reacts with the haloaminosilane compound and provides an end product mixture comprising the aminosilane compound and optionally reducing agent.

10. The method of claim 9 wherein at least a portion of the amine-hydrohalide byproduct is removed prior to the introducing step.

11. The method of claim 10 wherein the amino-hydrohalide byproduct is removed by at least one process selected from distillation, evaporation, membrane separation, filtration, vapor phase transfer, extraction, fractional distillation, and combinations thereof.

12. The method of claim 9 wherein the reducing agent is at least one selected from the group consisting of alkali aluminum hydride, alkali borohydride, alkali germanium hydride, alkali hydride, alkaline earth hydride, and combinations thereof.

13. The method of claim 9 further comprising: adding a neutralizing agent to the end product mixture to remove at least a portion of reducing agent comprised therein.

14. The method of claim 9 further comprising: removing the aminosilane compound from the end product mixture.

15. A method for making an aminosilane compound having the following formula:
H₃SiNR¹R²
wherein R¹ and R² are each independently selected from C₁-C₁₀ linear, branched or cyclic, saturated or unsaturated, aromatic, heterocyclic, substituted or unsubstituted alkyl groups wherein R¹ and R² are linked to form a cyclic group or wherein R¹ and R² are not linked to form a cyclic group, the method comprising the steps of:
reacting a halosilane having the formula HₙSiX₄₋ₙ wherein n is 0, 1, or 2 and X is Cl, Br, or a mixture of Cl and Br, and an amine to provide a slurry comprising a haloaminosilane compound X₄₋ₙHₙ₋₁SiN(CH(CH₃)₂)₂ wherein n is a number selected from 1, 2 and 3; and X is a halogen selected from Cl, Br, or a mixture of Cl and Br, provided that when X is Cl, n is not 1 or 2 and a amine-hydrohalide byproduct;
introducing into the slurry a reducing agent wherein at least a portion of the reducing agent reacts with the haloaminosilane compound and provides an end product mixture comprising the aminosilane compound and optionally reducing agent; and
optionally adding a neutralizing agent to the end product mixture to remove at least a portion of reducing agent comprised therein.

16. A haloaminosilane compound having the following formula:
X₄₋ₙHₙ₋₁SiN(CH(CH₃)₂)₂
wherein n is a number selected from 1, 2 and 3; and X is a halogen selected from Cl, Br, or a mixture of Cl and Br, provided that when X is Cl, n is not 1 or 2.

17. A method for making an aminosilane compound having the following formula:
H₃SiNR¹R²
wherein R¹ and R² are each independently selected from C₁-C₁₀ linear, branched or cyclic, saturated or unsaturated, aromatic, heterocyclic, substituted or unsubstituted alkyl groups wherein R¹ and R² are linked to form a cyclic group or wherein R¹ and R² are not linked to form a cyclic group, the method comprising the steps of:
reacting a halosilane comprising SiX₄, where X═Cl, Br, or combinations thereof and an amine to provide a slurry comprising a haloaminosilane compound X₄₋ₙHₙ₋₁SiN(CH(CH₃)₂)₂ wherein n is a number selected from 1, 2 and 3; and X is a halogen selected from Cl, Br, or a mixture of Cl and Br, provided that when X is Cl, n is not 1 and a amine-hydrohalide byproduct; and
introducing into the slurry a reducing agent wherein at least a portion of the reducing agent reacts with the haloaminosilane compound and provides an end product mixture comprising the aminosilane compound and optionally reducing agent.

18. The method of claim 17 wherein the molar ratio of halosilane to the amine in the reaction mixture is selected from the group consisting of 1 to 1, 1 to 2, and 1 to 2.2.

19. The method of claim 17 wherein the amine comprises diisopropylamine.
